(19) United States
(12) Patent Application Publication
(10) Pub. No.: US 2003/0080061 A1
(43) Pub. Date: May 1, 2003

(54) Method and system utilizing gravity and membranes to separate water and oil in a horizontal wellbore

(76) Inventors: David R. Underdown, Conroe, TX (US); Michael Dubrovsky, Richmond, CA (US)

Correspondence Address: Richard J. Schulte, Chevron Texaco Corporation, P.O. Box 6006, San Ramon, CA, 94583-0806, US

(21) Appl. No.: 10/000,637

(22) Filed: Oct. 30, 2001

(51) Int. Cl. B01D 17/00; B01D 61/00

(52) U.S. Cl. 210/650; 210/800; 210/806; 210/170; 210/294; 210/321.87

(57) ABSTRACT

A system and method for separating water and oil from a mixture of water and oil in a wellbore is disclosed. The system comprises a wellbore in fluid communication with an oil producing formation to receive a mixture of water and oil. The wellbore includes a horizontal portion and a vertical portion which extends to the wellbore surface. A string of tubing is disposed in the wellbore including segments of gravity tubing and segments of membrane tubing which both ideally disposed in the horizontal portion of the wellbore. The gravity tubing allows the mixture of water and oil to at least partially separate into a layer of oil and a layer of water. The membrane tubing includes a membrane which is selectively permeable to one of the water and oil. The water and oil are separated in the membrane tubing. The separated oil is transported to the well surface and the separated water is disposed of in a water disposal zone adjacent the wellbore. The membrane tubing may include a perforate outer tubing lined with a cylindrical or an arcuate membrane which allows water or oil to permeate through membrane tubing into the wellbore. Alternatively, the membrane tubing may include an outer tubing having upstream and downstream end plates. A plurality of membrane tubules stretching between the upstream and downstream end plates allow one of the water and oil to permeate through the membrane with the permeate being routed for collection on the well surface or else for disposal into a water disposal zone. Also, a separate disposal wellbore may used which connects to a main wellbore using a level 1-6 junction. The use of the junction and disposal wellbore eases the disposal of separated water.

### FIELD OF THE INVENTION

The present invention relates generally to producing oil from a wellbore, and more particularly, to separating fluids using membranes within a wellbore.

### BACKGROUND OF THE INVENTION

It is desirable to separate fluids in a wellbore containing hydrocarbons. Commercially valuable products such as hydrocarbon containing gases and oil are ideally delivered to a well surface for collection. Meanwhile, undesirable products such as water, CO₂, H₂S, nitrogen, and other trace gases, preferably are disposed of within the earth without ever being delivered to the surface. Processing and disposal of such products above ground presents environmental concerns and is generally quite expensive. Much of the expense is associated with the transport and disposal of these unwanted byproducts.

One example of a method and device for the separation of fluids in a well is described in patent application WO 98/41304. In this application, a mixture of oil and water is separated in a horizontal portion of a wellbore. Separated oil is delivered to a well's surface while water is disposed of in an adjacent disposal formation. Gravity is utilized to separate denser water from lighter oil. As the water and oil mixture passes horizontally along a pipe, the oil separates from water with oil floating upon the water to form a general water/oil interface. Separated oil above the interface is drawn off and passed by way of production tubing to the well surface. Meanwhile, water beneath the interface is generally passed to a formation in the earth for disposal.

One shortcoming of this method and device is that complex mechanisms are needed to ascertain the position or level of the oil/water interface or the particular concentration of an oil/water sample. Oil drawn off too close to the interface will contain an undesirably high percentage of water. Likewise, water drawn off too close the interface will contain excessive amounts of oil. Another drawback of this system is that other contaminants contained in the separated water may eventually plug a disposal formation.

Various methods and devices are suggested for monitoring the interface. For example, a gamma densiometer utilizing many sensors connected to a signal processing unit located in a wellbore may be used to detect the interface level and measure the concentration of an oil/water profile. Alternatively, it is suggested that oil in a water sample can be analyzed and used to control the level of the boundary layer. This analysis is performed by a taking small sub-flow of the water which is separated in the wellbore gravity separator and directing the sub-flow to the well surface for analysis/measurement.

Such a method and system which relies heavily on determining the characteristics of the boundary level in a separator by using electronic sensors is overly complicated. Consequently, a simpler method and system are needed which do not rely upon accurate boundary level measurements or upon timely and accurately measuring the oil/water concentration at discrete locations. Further, a method is needed wherein the purity of the water being separated can be determined and ideally can be of sufficient quality that it can be disposed of into a body of sea water while meeting applicable environmental standards.

Membrane separation has been suggested for separating oil and water in a vertical wellbore. For example, U.S. Pat. No. 4,241,787 to Price utilizes a membrane to separate water from oil. One drawback to this system is that oil from a water and oil mixture circumferentially contacts and may interfere with the passage of water through a water permeable membrane. The contacting oil and contaminants may foul the membrane leading to a much diminished permeability to water flow through the membrane.

There is a need for a method and apparatus for separating oil and water within a wellbore wherein oil contact with a water permeable membrane is minimized so as to reduce the aforementioned fouling and separation problems. Further, such a system should be simple and reliable and free of extraneous sensors and control devices as required by the system of WO 98/41304.

### SUMMARY OF THE INVENTION

An object of the present invention is to separate a water and oil mixture in the horizontal portion of a wellbore using a membrane with the separated oil being transported to a well surface and the separated water being disposed of in a water disposal zone in the earth.

It is a further object to provide a system and method using a gravity tubing in a horizontal portion of a wellbore wherein a mixture of oil and water can at least partially separate into a layer of oil and an underlying layer of water and further employing a separator apparatus including a membrane which is at least partially immersed in the water layer to separate water from oil with concentrated oil being transported to the layer of oil and the separated water being disposed into a water disposal zone.

It is still another object to provide a membrane separator in a wellbore wherein the flow of water past the membrane works to flush the membrane of foulants and to inhibit membrane fouling.

In accordance with the above objects, a system and method for separating water and oil from a mixture of water and oil in a wellbore is disclosed. The system comprises a wellbore in fluid communication with an oil producing formation to receive a mixture of water and oil. The wellbore includes a horizontal portion and a vertical portion which extends to the wellbore surface. A string of tubing is disposed in the wellbore including segments of gravity tubing and segments of membrane tubing which are both ideally disposed in the horizontal portion of the wellbore. The gravity tubing allows the mixture of water and oil to at least partially separate into a layer of oil and an underlying layer of water. The membrane tubing is in fluid communication with the gravity tubing and includes a membrane which is selectively permeable to the water. The water and oil are separated in the membrane tubing. The separated oil is transported to the well surface and the separated water is disposed of in a water disposal zone adjacent the wellbore or to the sea. The membrane tubing may include perforated outer tubing lined with a cylindrical or an arcuate membrane which allows water or oil to permeate through membrane tubing into the wellbore. Alternatively, the membrane tubing may include an outer tubing having upstream and downstream end plates. A plurality of membrane tubules stretching between the upstream and downstream end plates allows one of the water and oil to permeate through the membranes with the permeate being routed for collection on the well surface or else for disposal into a water disposal zone. The flow of separated water along the membrane helps to flush contaminants away from the membrane and to prevent the portion of the membrane exposed to water from fouling. By placing the membrane in the underlying water portion of the gravity separated water and oil mixture, the membrane is exposed to a minimum amount oil and contaminants as compared to membrane separations occurring in vertical wellbores. In these vertical wellbores, oil and water mixtures contact the entire circumference of membranes as opposed to only the portion of the membrane residing above a gravity induced water/oil interface. In another embodiment of this invention, a separate disposal branch is drilled to help accommodate the disposal of separated water. A multi-level junction, preferably levels 1-6, is used to fluidly connect the main wellbore to the disposal branch.

### BRIEF DESCRIPTION OF THE DRAWINGS

These and other objects, features and advantages of the present invention will become better understood with regard to the following description, pending claims and accompanying drawings where:

FIG. 1 is a schematic drawing of a system, made in accordance with the present invention, which uses gravity and a separator apparatus, including a membrane, to separate water and oil in a generally horizontal wellbore;

FIG. 2 is a longitudinal cross-sectional view of a segment of membrane tubing utilized in the system of FIG. 1;

FIG. 3 is a schematic elevational view of an alternative series of membrane tubing which may be used in the system of FIG. 1;

FIGS. 4a-d are sectional views taken along sections 4a-4a, 4b-4b, 4c-4c and 4d-4d of FIG. 3 demonstrating use of membranes of diminishing arcuate length;

FIG. 5 is a schematic sectional view of a system employing a third embodiment of a membrane tubing including a plurality of separator apparatus located within each segment of membrane tubing;

FIG. 6 is an enlarged schematic sectional view of an exemplary separator apparatus used in a segment of the membrane tubing of FIG. 5; and

FIG. 7 is another embodiment wherein in a disposal branch is drilled to help accommodate the disposal of water from a main wellbore.

### BEST MODE(S) FOR CARRYING OUT THE INVENTION

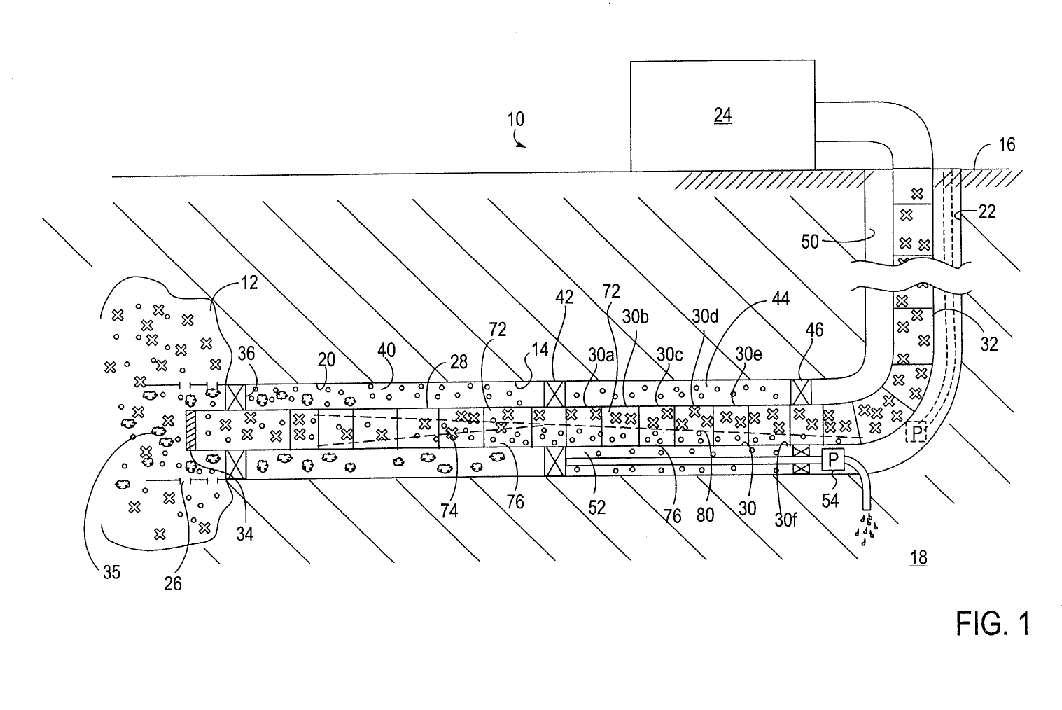

FIG. 1 schematically illustrates an exemplary system 10 made in accordance with the present invention. System 10 separates water and oil from a water and oil mixture received from an oil producing zone 12 within a wellbore 14. The separated oil is delivered to a well surface 16 while the separated water is disposed of into a disposal formation or reservoir 18. The separation occurs in a generally horizontally extending portion 20 of wellbore 14. Wellbore 14 further includes a vertically extending portion 22 which delivers the separated oil to well surface 16 for storage in a tank 24 or for further processing. Perforations 26 in wellbore 14 allow the water and oil mixture to enter into wellbore 14. The water disposal zone might be a formation in the earth or else a reservoir of water (not shown) such as a body of seawater. In order to dispose of the separated water in the body of seawater, the concentration of oil and other constituents in the separated water must, of course, be of satisfactory quality to meet appropriate environmental standards.

System 10 also includes a first string of gravity tubing 28, a second string of membrane tubing 30, and a third string of oil transporting tubing 32. Gravity tubing 28 and oil transporting tubing 32 are ideally comprised of segments of steel pipe. Similarly, membrane tubing 30 includes a string of steel pipe, however further having a water/oil membrane separation capability, as will be described below. Segments of gravity tubing 28, membrane tubing 30 and oil transporting tubing 32 are preferably threadedly joined together. Gravity tubing 28 and membrane tubing 30 are ideally disposed in horizontal portion 20 of wellbore 14 while oil transporting tubing 32 is primarily located in vertical portion 22. Ideally, a prefilter 34 is mounted on the upstream end of gravity tubing 28 and prevents large particles in the water and oil mixture from entering gravity tubing 28. Prefilter 34 is made of porous stainless steel strainer in this example. A conventional gravel pack 35 may be placed upstream of prefilter 34 to also remove some of the larger particulates. Porous gravel may be placed about gravity tubing 28 and membrane tubing 30 within the wellbore to provide support.

A first packer 36 is used to isolate a gravity annulus region 40, formed between gravity tubing 28 and wellbore 14, from oil producing zone 12. A second packer 42 is utilized to separate gravity annulus region 40 from a membrane annulus region 44 formed between membrane tubing 30 and wellbore 14. Finally, a third packer 46 separates membrane annulus region 44 from a corresponding annulus region 50 in wellbore 14 about oil transporting tubing 32. A water disposal conduit 52, ideally perforated along its length, resides in membrane annulus region 44. In this first exemplary embodiment of this invention, water disposal conduit 52 may extend through packer 46 and be connected to an auxiliary pump 54. Pump 54 provides sufficient pressure head to force separated water into disposal zone 18.

Membrane tubing 30 is shown in FIG. 1 including an exemplary number of segments 30a-f. The exact number of segments will depend on a number of factors including the rate of fluid passage through membrane tubing 30, the initial watercut of the water and oil mixture entering wellbore 14, the permeability and selectivity of a particular membrane material to be used at a given condition of temperature and pressure.

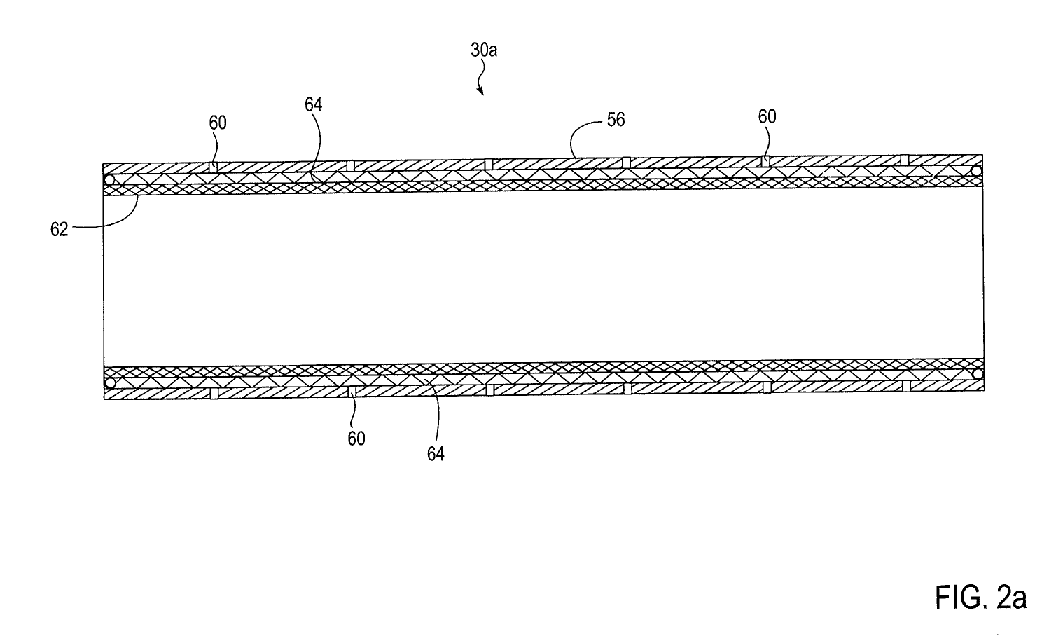

An exemplary segment 30a is shown in FIG. 2a. Membrane tubing segment 30a includes an outer tubing 56 having perforations 60 therein, an elongate cylindrical inner porous tubing 62, and a cylindrical membrane 64 captured between outer tubing 56 and inner tubing 52. Membrane 64 is ideally highly hydrophilic allowing water to readily pass therethrough while being quite selectively impermeable to oil. Examples of such hydrophilic membrane materials include modified polyacrylonitriles, modified polyethersulphones, alpha alumina, and zirconia. The most preferred membrane material is the modified polyacrylonitrile. Porous support structure 62 is ideally made of one of polyester or polysulphone, or metal or carbon fibers. Most preferably support structure 62 is made of a polyamide material.

Referring back to FIG. 1, in operation, the water and oil mixture enter wellbore 14 through perforations 26. After passing through prefilter 34, the mixture flows downstream through the length of gravity tubing 28. Under the influence of gravity, the water and oil mixture partially separate into a layer 72 composed primarily of oil which resides atop a layer 74 of mixed water and oil which, in turn, rests upon a layer 76 consisting primarily of water, as suggested in FIG. 1. Eventually, the water and oil mixture layer 74 is ideally eliminated with oil layer 72 resting upon water 76 with an oil/water interface 80 being formed therebetween. Of course, each of oil layer 72 and water layer 74 still contain a certain small percentage of water and oil, respectively.

Membrane tubing 30 utilizes membrane 64 to permeate water from oil and water layers 72 and 76 with the separated water passing through porous support structure 62 and perforations 60 in outer tubing 56 to reach membrane annulus region 44 within wellbore 14. Oil transporting tubing 32 then carries the concentrated oil, i.e., with a significant portion of the original water removed, to well surface 16 for collection in storage tank 24, or else, for further processing. Water disposal conduit 52 evacuates water from membrane annulus region 44 into water disposal formation 18. Note that as water is eliminated from membrane tubing 30, the thickness or depth of oil layer 72 will increase while the depth of water layer 76 decreases. Moreover, the velocity of longitudinal fluid flow through membrane tubing 30 decreases as the oil and water layers 72 and 76 proceed downstream due to the removal of water into membrane annulus region 44. Accordingly, water layer 76 will see enhanced residence time in each successive segment of membrane tubing 30 and be subsequently disposed of into water disposal formation 18. Ideally, membrane 64 is sufficiently selective such that the separated water permeate contains sufficiently low concentrations of oil such that the separated water can be disposed of into a reservoir of sea water while meeting applicable environmental standards and regulations.

Preferably membrane 64 is a hydrophilic membrane, as described above. However, it is also within the scope of this invention to use a hydrophobic membrane which is ideally highly permeable to oil while being selectively resistant to water passage. Examples of such membranes are polyamides, polyether sulphone, Polyviniydene (PVDF), PVC, and PTFE (Teflon). In this instance, system 10 would be plumbed to deliver the oil permeate, now in membrane annulus region 44, directly to oil transporting tubing 32 for delivery to storage tank 24. Consequently, the water residue of the original water and oil mixture at the end of membrane tubing 30 would be routed directly to water disposal formation 18 and sealed from oil transporting tubing 32.

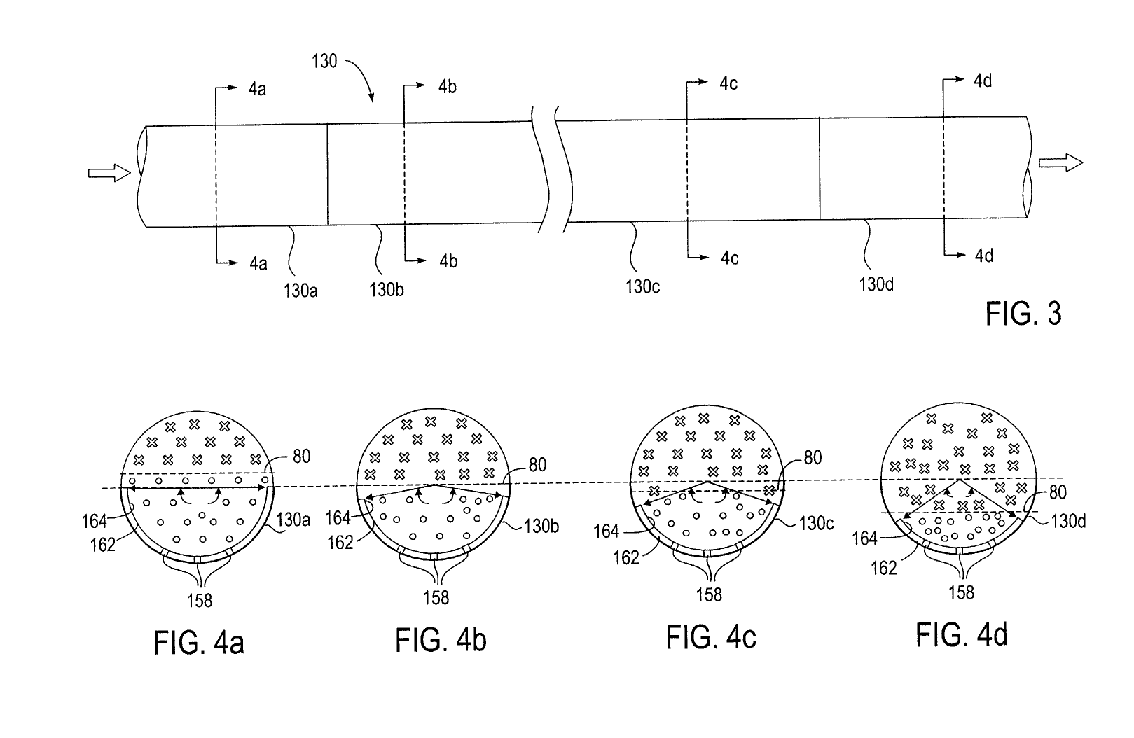

A second embodiment of this invention is shown in FIGS. 3 and 4a-d. In this embodiment, membrane tubing 30 is replaced with membrane tubing 130 which has inner membranes 164 which are arcuate to only partially circumferentially line the lower portions of a support structure 162 and a non-porous outer tubing 156, which is preferably steel. Support structure 162 may be either cylindrical or else sufficiently arcuate to support arcuate inner membrane 164. Membrane 164 is adhesively or otherwise secured as needed to support structure 162 at discrete locations to provide necessary structural support. Outer tubing 156 contains numerous openings 158 along its bottom to allow separated water to exit membrane tubing 130 and enter annulus 44.

In FIGS. 4a-e, support structure 162 is shown as being only sufficiently arcuate to support inner membrane 164. Membrane 164 is again ideally made of polyacrylonitrile. The upstream and downstream ends of support structure 162 and membrane 164 are imperviously sealed and secured to the respective upstream and downstream ends of outer tubing 156. Consequently, water and oil must permeate through membrane 164 to radially exit membrane tubing 130.

The membrane material is expensive to manufacture so minimizing the amount of membrane material used is desirable. Further, the selectivity and permeability of the membrane material to water is much higher in high concentrations of water as compared to high concentrations of oil. As the water and oil mixture move downstream through segments of membrane tubing 130, water is lost through permeation through membrane 164. Accordingly, the layer of oil floating upon the layer of water is increasing in thickness and the water/oil interface 80 is lowered. For purposes of explanation only, FIG. 3 shows a series of four segments of membrane tubing 130a-d. Again, the actual number of segments used will depend upon initial watercut, membrane permeability, flow rate, etc. FIGS. 4a-d display schematic cross-sectional views taken along the mid-lengths of these segments of membrane tubing 130. The arcuate lengths of membranes 164 ideally decrease as membrane tubing 130 proceeds downstream.

A general balance between providing a maximum contact between membrane 164 and the layer of water and keeping membrane 164 beneath the water/oil contact interface dictates the ideal arcuate length of each membrane 164 in a particular segment of membrane tubing 130. While the arcuate length may be the same within a particular segment, it is also possible to taper the arcuate length to decrease from the upstream end to the downstream end of a segment. Referring to FIGS. 4a-d, the arcuate length of membrane 64 is shown decreasing from 180° at the upstream segment 16a to about 90° at the downstream segment 16d. Note that the height of the water/oil contact interface similarly decreases as the water and oil mixture moves downstream. Separated water is again allowed to permeate out of membrane tubing 130 through openings 158 into wellbore 14 to be removed by water disposal conduit 52.

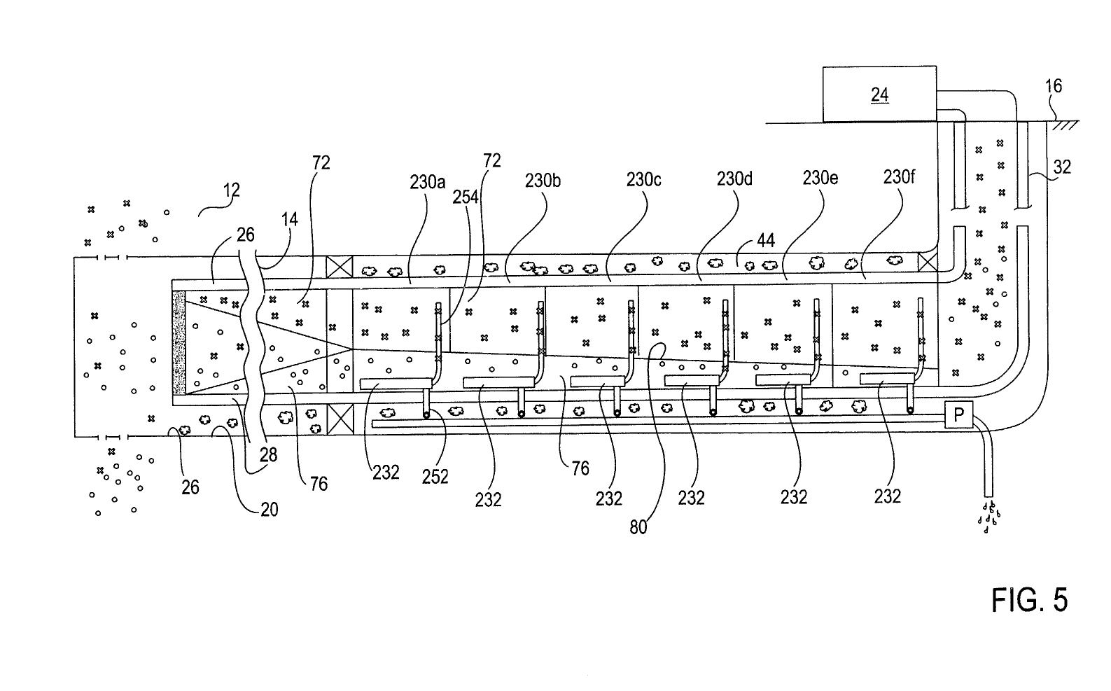

FIG. 5 illustrates a third embodiment of this invention wherein a mixture of water and oil is separated in a horizontal portion 20 of a wellbore 14. A series of membrane tubing 230a-f are located downstream from gravity tubing 28. Preferably located in each of the segments of membrane tubing 230 is an elongate separator apparatus 232. Each of separator apparatus 232 is ideally disposed beneath the oil/water interface 80 as shown in FIG. 5. The oil/water interface 80 again drops in height as water is separated in membrane tubing 230 and passed to water disposal conduit 52.

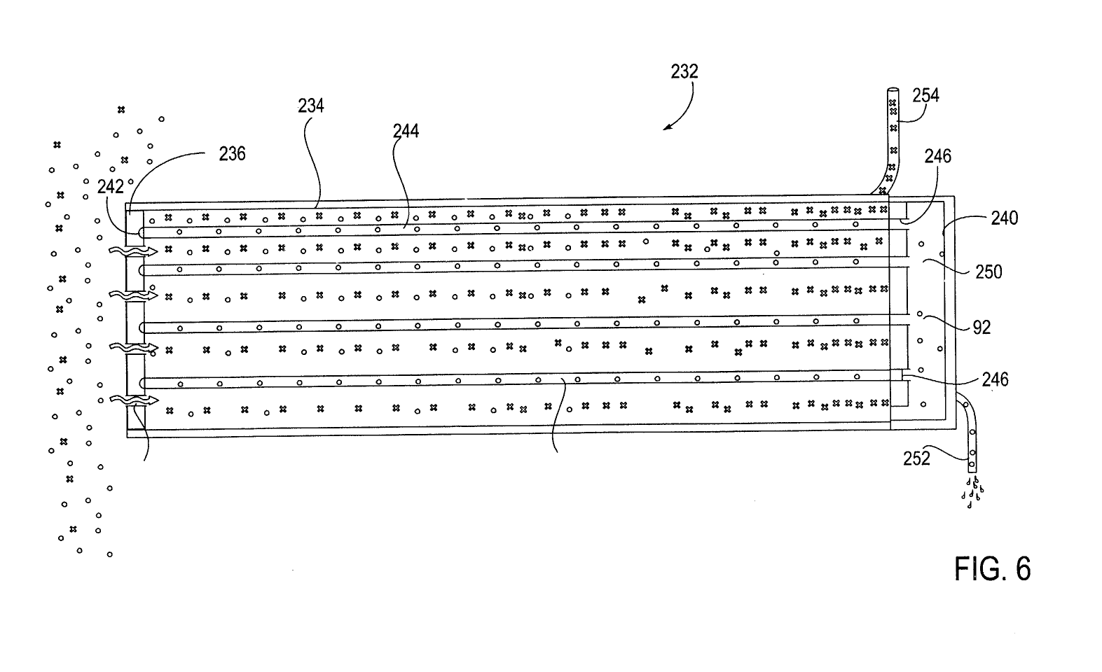

An exemplary separator apparatus 232 is depicted in FIG. 6 which depicts a vertical longitudinal sectional view taken through separator apparatus 232. Separator apparatus 232 includes a non-porous outer tubing 234 which has upstream and downstream end plates 236 and 240 installed therein. Upstream end plate 236 has numerous openings 242 therein to allow easy access of water from water layer 76 into outer tubing 234. A series of elongate hollow membrane tubules 244 are attached to and are stretched between upstream and downstream end plates 236 and 240. The upstream ends of member tubules 244 are closed and are sealingly captured by upstream end plate 240. The downstream ends of membrane tubules 244 are open and pass through corresponding openings 246 in downstream end plate 240. Tubules 244 are sealed within openings 240 to prevent oil from entering end plate 240. Formed within downstream end plate 240 is a collection chamber 250 for collecting water received from membrane tubules 244. Membrane tubules 244 are ideally highly hydrophilic and allow water to permeate radially inwardly into membrane tubules 244 while selectively inhibiting the passage of oil.

A water disposal tube 252 extends from collection chamber 250 to deliver separated water to membrane annulus region 44. Again, water disposal conduit 52 may be connected to a pump 54, if necessary, to inject the separated water to a water disposal formation or reservoir of water, such as a body of seawater. Concentrated oil remaining in separation apparatus 232 after water has been withdrawn by membrane tubules 244 is routed through an oil transfer tube 254 and is deposited near the top of oil layer 72 in membrane tubing 230. Consequently, the level of oil in membrane tubing 230 becomes greater in depth and of increased concentration as the water and oil mixture proceeds downstream through membrane tubing 230.

While separator apparatus 232 are shown extending the entire length of a segment of membrane tubing 230, those skilled in the art will appreciate that one or more shorter separator apparatus 232 could be arranged in a single segment of membrane tubing 230 with separated water being delivered to membrane annulus region 44 in wellbore 14. Also, while membrane tubules 244 are shown extending straight from upstream end plate 236 to downstream end plate 240, membrane tubules 244 could be spirally wound about one another. By spirally winding the membrane tubules 244 about one another, the overall length of each membrane tubule 244 stretched between end plates 236 and 240 becomes longer. Consequently, the overall surface area of the membrane material exposed to water within separator apparatus 232 is increased using this spiral winding of tubules 244 as compared to using straight tubules 244.

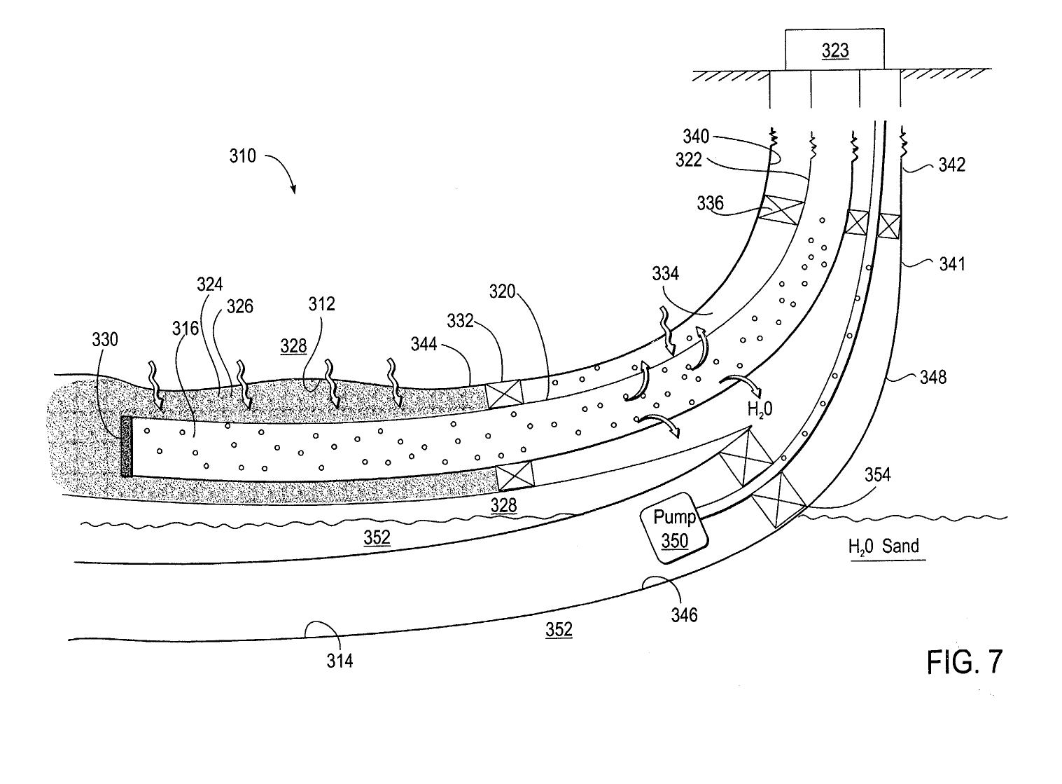

FIG. 7 shows an alternative system 310 for separating oil and water. System 310 includes a main wellbore 312 and a disposal wellbore 314. Located with main wellbore 312 is a perforated collection pipe 316, a perforated membrane pipe 320 and a non-perforated vertical pipe 322 which leads to a wellhead 323 on the well's surface. An open hole completion or sand completion 324 is located in a first annulus 326 between collection pipe 316 and wellbore 312. Surrounding this annulus is an oil producing formation 328. The sand completion 324 prevents particulates from entering into perforated collection pipe 316 while freely allowing a mixture of oil and water to enter perforated collection pipe 316 from oil producing formation 328.

A closed cap 330 seals the upstream end of collection pipe 316. A first packer 332 separates the first annulus 326 from a second annulus 334 located between perforated membrane pipe 320 and main wellbore 312. A second packer 336 separates a third annulus 340 located between vertical pipe 322 and main wellbore 312.

A casing 341 includes a main vertical casing 342 which bifurcates into a collection casing 344 located in wellbore 312 and a disposal casing 346 located in disposal branch 314. A multilateral junction 348 joins collection casing 344 and branch 346. Ideally multilateral junction 348 is a level 1-6 junction, more preferably a level 3-4 junction, and most preferably is a level 3 junction.

Membrane pipe 320 is similar to that described previously with respect to membrane segments 30. It has a perforated outer pipe, a porous inner support and a hydrophilic membrane with is suited to permeate water while retaining oil. A pump 350, such as an ESP pump, may also be installed into disposal branch 314 if needed to assist in the disposal of water into a disposal formation 352 surrounding disposal branch 314. A disposal packer 354 may be used to separate the disposal branch 314 from annulus 334.

In operation, a water and oil mixture from oil bearing formation 328 passes through completion 324 and enters perforations in collection pipe 316. The water and oil travel downstream in the horizontal collection pipe 316 ideally separating into water and oil layers. Upon entering membrane pipe 320, water is allowed to permeate through the membrane and into disposal branch 314. Concurrently, the increasing concentrated retentate oil is delivered to the wellhead 323 and well surface through vertical pipe 322.

While in the foregoing specification this invention has been described in relation to certain preferred embodiments thereof, and many details have been set forth for purpose of illustration, it will be apparent to those skilled in the art that the invention is susceptible to alteration and that certain other details described herein can vary considerably without departing from the basic principles of the invention.

What is claimed is:

1. A system for separating water and oil from a mixture of water and oil in a wellbore, the system comprising:
(a) a wellbore in fluid communication with an oil producing formation to receive a water and oil mixture and extending to a well surface, the wellbore including a horizontal portion which extends generally horizontally and a vertical portion which extends generally vertically to reach the well surface;
(b) a string of tubing disposed within the wellbore, the string of tubing including gravity tubing disposed within the horizontal portion of the wellbore and including membrane tubing also disposed within the wellbore, the gravity tubing allowing the water and oil mixture to at least partially separate under the influence of gravity into a layer of oil and a layer of water, the oil layer residing above the water layer, and the membrane tubing including a membrane which is selectively permeable to allow one of the water and oil to permeate therethrough while selectively inhibiting the passage of the other of the oil and water;
(c) wherein oil separated by the membrane is delivered to the well surface and water separated by the membrane is discharged into a water disposal zone beneath the well surface.

2. The system of claim 1 wherein the membrane is hydrophilic allowing water to pass readily therethrough while inhibiting the passage of oil.

3. The system of claim 1 wherein the membrane tubing includes an outer tubing which is lined with the membrane.

4. The system of claim 3 wherein the membrane is cylindrical.

5. The system of claim 3 wherein the membrane is arcuate.

6. The system of claim 5 wherein the membrane is immersed within the layer of water.

7. The system of claim 5 wherein the membrane tubing includes a plurality of segments of outer tubing and the segments of outer tubing are lined with the arcuate membranes, the arcuate membranes diminishing in arc length as the membrane tubing extends downstream in the wellbore.

8. The system of claim 3 wherein the membrane tubing further includes a support structure interposed between the outer tubing and the membrane to provide support to the membrane.

9. The system of claim 3 wherein the outer tubing is perforated and water may permeate through the membrane and the outer tubing and into the wellbore while the remainder of the water and oil mixture continues to flow downstream within the wellbore.

10. The system of claim 9 further comprising a water disposal conduit which disposes of water held within the wellbore to a water disposal zone.

11. The system of claim 1 wherein membrane tubing further includes at least one separator apparatus immersed in the layer of water, the separator apparatus including an outer tubing with the membrane disposed therein and an oil transfer conduit, the separator apparatus separating water and oil from the layer of water with the separated oil being passed by the oil transfer conduit to the layer of oil.

12. The system of claim 1 wherein the string of tubing further includes an oil transporting tubing which carries separated oil from the membrane tubing to the well surface.

13. The system of claim 1 wherein:
(a) the membrane tubing includes an outer tubing with a plurality of membrane planks which have a hollow central support structure covered with the membrane, the membrane planks extending longitudinally within the outer tubing and being spaced apart from one another to form a plurality of elongate isolated chambers within the outer tubing, the planks being orientated at angles from the horizontal;
(b) a liquid disposal tubing in fluid communication with the hollow center of the membrane planks and with the wellbore; and
(c) wherein when oil and water flow through the membrane tubing, the water and oil at least partially separate from one another to form individual oil and water layers in each of the chambers with one of the water and oil permeating through the membrane and being collected within the hollow central support structure for disposal into the wellbore through the disposal tubing.

14. A method of separating water and oil in a wellbore, the method comprising the steps of:
(a) receiving a mixture of water and oil into a wellbore from an oil producing zone, the wellbore having a horizontal portion which extends generally horizontally and a vertical portion which extends generally vertically to a well surface;
(b) passing the water and oil mixture along the horizontal portion of the wellbore wherein, under the influence of gravity, the water and oil mixture at least partially separate into a layer of oil and a layer of water;
(c) passing at least one of the layer of water and the layer of oil through a membrane tubing having a membrane therein with the membrane selectively permeating one of water and oil therethrough while inhibiting the passage of the other of the water and oil to separate oil from water;
(d) disposing of the separated water into a water disposal zone beneath the well surface and transporting the separated oil to the well surface.

15. The method of claim 14 wherein the membrane tubing includes a perforated outer tubing and the membrane at least partially lines the outer tubing.

16. The method of claim 15 wherein membrane is cylindrical.

17. The method of claim 15 wherein membrane is arcuate, and the membrane is at least partially immersed within the layer of water.

18. The method of claim 15 wherein the membrane is immersed in the layer of water.

19. The method of claim 14 wherein the membrane tubing includes a separator apparatus an outer tubing with upstream and downstream end plates, the separator apparatus being at least partially immersed in the layer of water.

20. The method of claim 14 wherein:
(a) a plurality of hollow membrane tubules extend from the upstream end plate to the downstream end plate; and
(b) water selectively permeates through the hollow membrane tubules and is collected in the downstream end plate and disposed of into a water disposal formation.
